(19) United States
(12) Patent Application Publication
(10) Pub. No.: US 2011/0032635 A1
(43) Pub. Date: Feb. 10, 2011

(54) MAGNETIC RECORDING MEDIUM AND METHOD FOR MANUFACTURING THE SAME, AND MAGNETIC RECORDING REPRODUCING APPARATUS

(75) Inventor: Masato Fukushima, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku (JP)

(21) Appl. No.: 12/936,146

(22) PCT Filed: Apr. 2, 2009
(86) PCT No.: PCT/JP2009/056882

§ 371 Date: Oct. 1, 2010

(30) Foreign Application Priority Data
Apr. 4, 2008 (JP) 2008-098106

(51) Int. Cl. G11B 5/82; G11B 21/02; H05H 1/24; B05D 5/12

(52) U.S. Cl. 360/75; 360/135; 427/576; 427/130; G9B/5.293; G9B/21.003

(57) ABSTRACT

A magnetic recording medium of the present invention includes, on a substrate (1), at least a magnetic layer (2) and a carbon protective layer (9) that covers the magnetic layer (2), wherein a convex part (7) serving as a magnetic recording area, and a concave part (6) serving as a boundary area that separates the magnetic recording area are provided on the surface of the magnetic layer (2), and a barrier layer (8) containing mainly Cr or Ti is formed between the concave part (6) serving as the boundary area and the carbon protective layer (9).

### TECHNICAL FIELD

The present invention relates to a magnetic recording medium used for a magnetic recording reproducing apparatus (hard disk drive) and a method for manufacturing the same, and a magnetic recording reproducing apparatus.

This application claims priority on Japanese Patent Application No. 2008-098106 filed on Apr. 4, 2008, the disclosure of which is incorporated by reference herein.

### BACKGROUND ART

Recently, magnetic recording has been utilized, for example, for magnetic recording reproducing apparatus, flexible disk devices and magnetic tape devices, and its applicability has increased significantly and its importance has also increased. Recording density of magnetic recording media used for these devices has been increased significantly.

With the introduction of an MR head and a PRML technology, surface recording density has improved still more significantly. In recent years, GMR heads and TMR heads have also been introduced, which further increase the surface recording density by about 100% per year.

Accordingly, there is a demand to further increase recording density of these magnetic recording media. Specifically, it is required to increase a coercive force, a signal-to-noise ratio (SNR) and resolution of magnetic layers. In recent years, efforts have been made to increase surface recording density by increasing linear recording density and track density.

The most recent magnetic recording reproducing apparatus has track density of as high as 110 kTPI. As the track density increases, however, magnetic recording information between adjacent tracks begins interfering with each other, which may easily cause a problem that a magnetizing transition area of a border area becomes a noise source that decreases the SNR. The decrease in the SNR causes a decrease in a bit error rate, which is an obstacle to an improvement in recording density.

In order to increase surface recording density, it is necessary to provide reduced-sized recording bits on the magnetic recording medium, each recording bit having maximum possible saturation magnetization and maximum possible magnetic film thickness. There is a problem, however, that the reduced-sized recording bit has a small magnetizing minimum volume per 1 bit and recorded data may disappear due to flux reversal caused by heat fluctuation.

Since adjacent tracks are close to each other in a high track density configuration, a significantly precise track servo technique is necessary for a magnetic recording reproducing apparatus. Therefore, information is recorded on a larger number of tracks and reproduced in a smaller number of tracks in order to avoid influence from adjacent tracks as much as possible. In this manner, however, although influence between the tracks can be controlled to the minimum, it is difficult to obtain a sufficient reproduction output and thus to provide a sufficient SNR.

In order to avoid the above heat fluctuation problem and to provide a sufficient SNR and to provide sufficient output, an attempt has been made to form a concavo-convex configuration along the recording tracks on the surface of the magnetic recording medium so as to physically separate the recording tracks from one another to increase the track density (hereinafter, such a technique is usually referred to as a discrete track method, and a magnetic recording medium manufactured by this discrete track method is referred to as a discrete track medium). An attempt has also been made to provide a so-called patterned medium that has further divided data areas in the same track.

There is known, as an example of the discrete track medium, a magnetic recording medium in which a magnetic layer is formed on a non-magnetic substrate with a concavo-convex pattern formed on the surface to form a physically-separated magnetic recording track and a servo signal pattern (see, for example, Patent Document 1).

The disclosed magnetic recording medium includes a ferromagnetic layer formed on the surface of a substrate with plural concavo-convex configurations on the surface via a soft magnetic layer, a protective film being formed on the surface of the ferromagnetic layer. The magnetic recording medium has, in its convex area, a magnetic recording area which is physically separated from the surrounding areas. According to the magnetic recording medium, since formation of a magnetic wall in the soft magnetic layer can be avoided and influence of the heat fluctuation can be prevented, there is no interference between adjacent signals. Thus, a high-density magnetic recording medium with less noise can be provided.

The discrete track method includes a method of physically forming tracks after a magnetic recording medium consisting of several thin film layers is formed, and a method of forming a concavo-convex pattern on a substrate surface and then forming a thin magnetic recording medium film (see, for example, Patent Documents 2 and 3).

As the method of physically separating an area between magnetic tracks of a discrete track medium, a method of injecting nitrogen ions and oxygen ions into a preliminarily formed continuous magnetic layer or by irradiating with laser so as to change magnetic characteristics of that area is disclosed (see, for example, Patent Documents 4 to 6).
[Patent Document 1] Japanese Unexamined Patent Application, First Publication No. 2004-164692
[Patent Document 2] Japanese Unexamined Patent Application, First Publication No. 2004-178793
[Patent Document 3] Japanese Unexamined Patent Application, First Publication No. 2004-178794
[Patent Document 4] Japanese Unexamined Patent Application, First Publication No. Hei 5-205257
[Patent Document 5] Japanese Unexamined Patent Application, First Publication No. 2006-209952
[Patent Document 6] Japanese Unexamined Patent Application, First Publication No. 2006-309841

### DISCLOSURE OF THE INVENTION

### Problems to be Solved by the Invention

As described above, in the step of manufacturing a discrete track medium and a patterned media, in order to form a physically separated magnetic recording area, there is used a method of forming a separated magnetic recording pattern on a magnetic layer by subjecting to reactive plasma including oxygen or halogen, or reactive ions, or a method of forming a separated magnetic recording area by injecting ions into a magnetic layer (hereinafter referred to as a magnetic layer modifying method).

These manufacturing methods are methods for manufacturing a discrete track medium and patterned media by forming a mask layer on the surface of a magnetic layer; patterning the mask layer using photolithographic technology; and injecting ions into a boundary area of a magnetic recording area, thereby causing deterioration of magnetic characteristics of the portion, or non-magnetizing the portion.

These manufacturing methods are excellent in that the manufacturing process can be simplified and that an influence of contamination of the magnetic recording medium in the manufacturing process can be decreased as compared with a manufacturing method in which a non-magnetic material is buried in a boundary area by physically processing a magnetic layer and then the surface is smoothened (hereinafter referred to as a magnetic layer processing method).

On the other hand, in the magnetic recording medium manufactured by these methods, since the portion where partial irradiation with ions and injection of ions are conducted to the continuous magnetic layer is slightly removed (etched) relative to the other portion, a difference in level is formed between the magnetic recording area and the neighboring boundary area. In this case, the surface can be smoothed by filling the portion having a difference in level with other substances. However, when such a method is used, a merit of a magnetic layer modifying method to a magnetic layer processing method disappears.

Although high smoothness is required to the surface of the magnetic recording medium, based on the viewpoint that a sight concavo-convex configuration is permitted, a carbon film was formed on a magnetic layer by a CVD method in a state where a concavo-convex configuration remains between the magnetic recording area and the boundary area of the above magnetic layer. As a result, it was found that the thickness of the carbon film at the concave part where ions are injected becomes smaller than that of convex part where ions are not injected, although it depends on film formation conditions of the carbon film. This reason is considered that carbon radicals formed by the CVD method is concentrated on the convex part of the surface of the substrate and nucleation of carbon at the portion is preferentially conducted, and thus the thickness of the carbon film of the convex part becomes larger than that of the other portion.

The carbon protective layer to be formed on the surface of the above magnetic recording medium has, in addition to a function of protective the magnetic recording medium from contacting with the magnetic head, a function of preventing the magnetic layer from corroding (oxidizing) due to moisture in atmospheric air.

As is apparent from the present inventors' study, in a magnetic recording medium including at least a magnetic layer and a carbon protective layer formed on a substrate, if a concavo-convex configuration is present on the surface of the magnetic layer, the thickness of the carbon protective layer that covers the concave part of the magnetic layer becomes smaller, and thus corrosion of the magnetic layer is likely to proceeds from the portion. This reason is considered that, since the carbon protective layer at the concave part of the magnetic layer is simply is thin, the corrosion of this area proceeded and also there is a difference in the thickness of the carbon protective layer on the surface of the magnetic layer. Therefore, it became apparent that, when the carbon protective layer has a distribution in a thickness direction and a material that is likely to be corroded is present under the thin portion of the carbon protective layer, corrosion at the portion is accelerated.

The present invention has been made in view of the aforementioned related art problems, and an object thereof is to provide a magnetic recording medium that prevents corrosion to be generated in the above magnetic layer, thus enabling an improvement in environmental resistance, and a method for manufacturing the same, and a magnetic recording reproducing apparatus using the magnetic recording medium.

### Means to Solve the Problems

The present invention provides the following means.
(1) A magnetic recording medium including, on a substrate, at least a magnetic layer and a carbon protective layer that covers the magnetic layer, wherein
   a convex part serving as a magnetic recording area, and a concave part serving as a boundary area that separates the magnetic recording area are provided on the surface of the magnetic layer, and
   a barrier layer containing mainly Cr or Ti is formed between the concave part serving as the boundary area and the carbon protective layer.
(2) The magnetic recording medium according to (1), wherein the boundary area is formed by modifying a portion of the magnetic layer.
(3) The magnetic recording medium according to (1) or (2), wherein the thickness of the carbon protective layer on the magnetic recording area is more than the thickness of the carbon protective layer on the boundary area.
(4) The magnetic recording medium according to any one of (1) to (3), wherein the thickness of the barrier layer is from 0.3 to 5 nm.
(5) A method for manufacturing a magnetic recording medium, including the steps of:
   forming a magnetic layer on a substrate;
   forming a concave part serving as boundary area that separates a magnetic recording area, on the surface of the magnetic layer;
   forming a barrier layer containing mainly Cr or Ti at the concave part; and
   forming a carbon protective layer that covers the magnetic layer and the barrier layer.
(6) The method for manufacturing a magnetic recording medium according to claim 5, wherein the step of forming the concave part serving as the boundary area that separates the magnetic recording area, on the surface of a magnetic layer includes the substeps of:
   forming a mask layer on the magnetic layer;
   forming a resist layer on the mask layer;
   forming a concave part at the position corresponding to the boundary area of the resist layer;
   removing the mask layer at the part corresponding to the concave part; and
   exposing the exposed surface of the magnetic layer at a portion where the mask layer is removed, to reactive plasma or reactive ions, thereby modifying the magnetic layer at the part.
(7) The method for manufacturing a magnetic recording medium according to (6), wherein, in the substep of forming the concave part at the position corresponding to the boundary area of the resist layer, the resist layer is irradiated with radiation in a state where a stamp is pressed against the resist layer, thereby transferring a shape of the stamp to the resist layer.
(8) The method for manufacturing a magnetic recording medium according to (6) or (7), wherein a portion of the magnetic layer at a portion where the mask layer is removed is removed through ion milling.
(9) The method for manufacturing a magnetic recording medium according to (6), wherein the step of forming the barrier layer containing mainly Cr or Ti at the concave part includes the substeps of:
   forming the barrier layer on the surface of the magnetic layer and on the resist layer; and
   removing the resist layer and the mask layer and also removing the barrier layer on the resist layer through lift-off.
(10) The method for manufacturing a magnetic recording medium according to (9), wherein, when the barrier layer formed on the magnetic recording area of the magnetic layer is selectively removed, the surface of the magnetic recording area is irradiated with ion beam from an oblique direction.
(11) A magnetic recording reproducing apparatus including:
   the magnetic recording medium according to any one of (1) to (4);
   a medium driving unit that drives the magnetic recording medium in a recording direction;
   a magnetic head that performs a recording operation and a reproducing operation to the magnetic recording medium;
   a head moving unit that moves the magnetic head relative to the magnetic recording medium; and
   a recording reproducing signal processing unit that inputs signals to the magnetic head and reproduces signals output from the magnetic head.

### Effects of the Invention

As described above, according to the invention, it is possible to provide a magnetic recording medium that is excellent in corrosion resistance of a magnetic layer and has particularly high environmental resistance under a high-temperature and high-humidity environment, and is also excellent in productivity; and a method for manufacturing the same; and a magnetic recording reproducing apparatus using the magnetic recording medium.

### BRIEF DESCRIPTION OF THE DRAWINGS

FIG. 1A is a cross-sectional view for explaining a magnetic layer of a magnetic recording medium to which the invention is applied.

FIG. 1B is a cross-sectional view for explaining a magnetic layer of a magnetic recording medium to which the invention is applied.

FIG. 1C is a cross-sectional view for explaining a magnetic layer of a magnetic recording medium to which the invention is applied.

FIG. 2 is cross-sectional view for explaining a step of manufacturing a magnetic recording medium to which the invention is applied, which shows a step A.

FIG. 3 is cross-sectional view for explaining a step of manufacturing a magnetic recording medium to which the invention is applied, which shows a step B.

FIG. 4 is cross-sectional view for explaining a step of manufacturing a magnetic recording medium to which the invention is applied, which shows a step C.

FIG. 5 is cross-sectional view for explaining a step of manufacturing a magnetic recording medium to which the invention is applied, which shows a step D.

FIG. 6 is cross-sectional view for explaining a step of manufacturing a magnetic recording medium to which the invention is applied, which shows a step E.

FIG. 7 is cross-sectional view for explaining a step of manufacturing a magnetic recording medium to which the invention is applied, which shows a step F.

FIG. 8 is cross-sectional view for explaining a step of manufacturing a magnetic recording medium to which the invention is applied, which shows a step G.
FIG. 9 is cross-sectional view for explaining a step of manufacturing a magnetic recording medium to which the invention is applied, which shows a step H.

FIG. 10 is cross-sectional view for explaining a step of manufacturing a magnetic recording medium to which the invention is applied, which shows a step I.

FIG. 11 is cross-sectional view for explaining a step of manufacturing a magnetic recording medium to which the invention is applied, which shows a step J.

FIG. 12 is a cross-sectional view showing a step of removing a barrier layer.

FIG. 13 is a perspective view of an exemplary configuration of a magnetic recording reproducing apparatus to which the invention is applied.

### DESCRIPTION OF REFERENCE NUMERALS

1: Non-magnetic substrate
2: Magnetic layer
3: Mask layer
4: Resist layer
5: Stamp
6: Boundary area (concave part)
7: Magnetic recording area (convex part)
8: Barrier layer
9: Carbon protective layer
31: Magnetic disk (magnetic recording medium)
32: rotation driving section (medium driving section)
33: Magnetic head
34: Head driving section (head moving means)
35: Recording and reproducing signal processing system (Recording and reproducing signal processing means)
100: Magnetic layer
101: Convex part
102: Concave part
103: Carbon protective layer
M: Magnetic recording area
S: Boundary area

### BEST MODE FOR CARRYING OUT THE INVENTION

A magnetic recording medium and a method for manufacturing the same, and a magnetic recording reproducing apparatus, to which the present invention is applied, will be described in detail with reference to the accompanying drawings.

For the ease of understanding, characteristic features in the drawings referred to in the following description are enlarged in some drawings. Accordingly, components are not necessarily illustrated in actual dimensional ratios.

### (Magnetic Recording Medium)

The magnetic recording medium to which the present invention is applied is characterized by including at least a magnetic layer and a carbon protective layer, formed on a substrate, a convex part serving as a magnetic recording area, and a concave part serving as a boundary area that separates the magnetic recording area being provided on the surface of the magnetic layer, and a barrier layer containing mainly Cr or Ti being formed between a boundary area of the magnetic layer and the carbon protective layer.

Specifically, when the magnetic recording medium is viewed from the surface side, a separated magnetic recording area is formed by forming a non-magnetized boundary area on a continuous magnetic layer. In the present invention, when the magnetic layer is viewed from the surface side, the magnetic recording area may be separated by the boundary area and, even if the magnetic recording area is not separated at the bottom of the magnetic layer, it is possible to achieve the object of the present invention as the separated magnetic recording area of the present invention (the surface of the magnetic layer refers to the surface at the magnetic head side of the magnetic layer (opposite the surface at the substrate side of the magnetic layer) and, even if the surface of the magnetic layer itself is covered with a carbon protective layer, it is illustrated as the surface of the magnetic layer in the following description).

Namely, the present invention can be applied to a discrete track type magnetic recording medium that is intended to increase track density by forming a concavo-convex configuration along recording tracks on the surface of a magnetic layer thereby physically separating the recording tracks with each other. In this case, the magnetic recording area forms a magnetic recording track and a servo signal pattern. Furthermore, the present invention can be applied to patterned media in which magnetic recording areas are disposed with given regularity every 1 bit, media in which magnetic recording areas are disposed in the form of a track, and a magnetic recording medium including the other servo signal pattern. Among them, a discrete type magnetic recording medium is preferred so as to apply the present invention in view of handiness in manufacture of the magnetic recording medium.

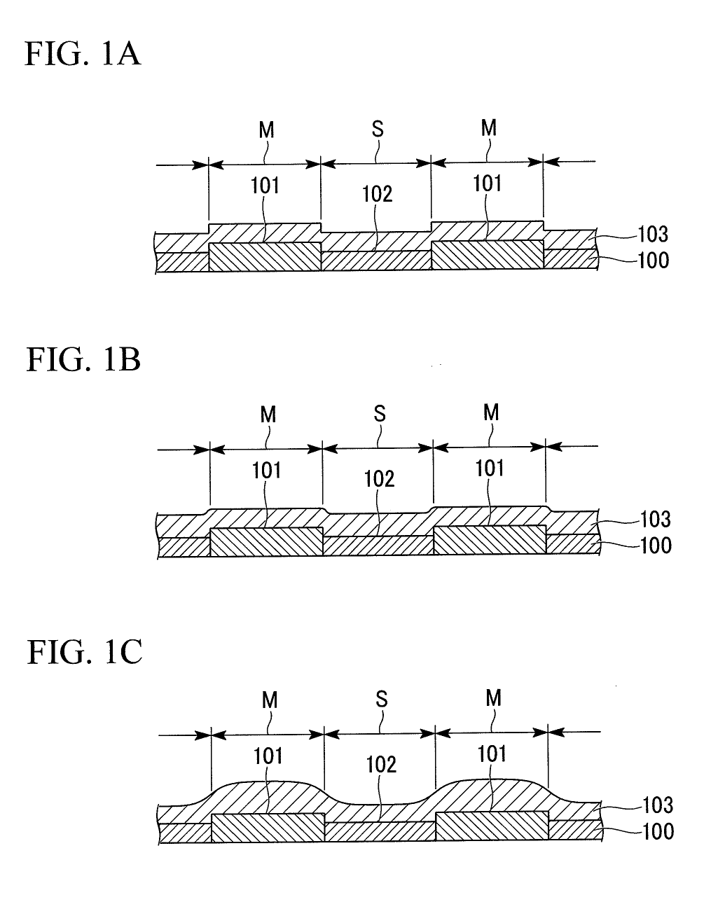

Herein, the magnetic layer as a characterizing portion of the magnetic recording medium to which the present invention is applied is described. As shown in FIG. 1A to FIG. 1C, the surface of a magnetic layer 100 of each magnetic recording medium is provided with a convex part 101 serving as a magnetic recording area M, and a concave part 102 serving as a boundary area S that separates the magnetic recording area M.

In the case of the magnetic recording medium shown in FIG. 1A among magnetic recording media, when the portion that would be turned into the boundary area S of a continuous magnetic layer 100 undergoes irradiation with ions or injection of ions, plural concave parts 102 in which the portion is slightly etched are formed, and the convex part 101 serving as the magnetic recording area M is formed between these plural concave parts 102. These plural concave parts 102 can also be formed at the portion that would be turned into the boundary area S of the continuous magnetic layer 100 by ion milling described hereinafter.

On the magnetic layer 100 on which the convex part 101 and the concave part 102 (concavo-convex) are formed, a carbon protective layer 103 is formed using a PVD method (physical vapor deposition method). In this case, the thickness of the carbon protective layer 103 is the same on the surfaces of the convex part 101 and the concave part 102. On the surface of the carbon protective layer 103, a concavo-convex configuration having almost the same height (depth) as those of the convex part 101 and the concave part 102 formed on the surface of the magnetic layer 100 is formed.

On the other hand, in the case of the magnetic recording medium shown in FIG. 1B, on the magnetic layer 100 on which the convex part 101 and the concave part 102 are formed, a carbon protective layer 103 is formed using a CVD method (chemical vapor deposition method). In this case, the thickness of the carbon protective layer 103 on the surface of the boundary area S (concave part 102) where ions are injected may be sometimes larger than that on the surface of the magnetic recording area M (convex part 101) where ions are not injected.

This reason is considered that, at the portion where ions are injected of the magnetic layer 100, an ultrafine concavo-convex configuration is foamed on the surface and probability of adhesion of reactive radicals at the portion increases, and thus nucleation of carbon at this portion is preferentially conducted and the thickness of the carbon protective layer 103 at the ion injection portion becomes larger than that at the other portions. Such a tendency is preferred so as to enhance smoothness of the surface of the magnetic recording medium since it acts to reduce a difference of elevation between the convex part 101 and the concave part 102 formed on the surface of the magnetic layer 100.

However, the present invention is unsuited for the magnetic recording medium having such a concavo-convex configuration. Namely, in the case of this magnetic recording medium, since the carbon protective layer 103 has a large thickness in the peripheral portion of the magnetic recording area M, corrosion of the magnetic layer 100 does not generate from this portion. It is considered that a barrier layer is provided between the magnetic recording area M of the magnetic layer 100 and the carbon protective layer 103 in the magnetic recording medium having such a concavo-convex configuration. However, when such a constitution is adopted, a distance between the magnetic recording area M and the magnetic head increases, resulting in deterioration of electromagnetic conversion characteristics of the magnetic recording medium.

On the other hand, the present invention is applied to the magnetic recording medium in which the thickness of the carbon protective layer 103 on the surface of the magnetic recording area M (convex part 101) becomes larger than that on the surface of the boundary area S (concave part 102), as shown in FIG. 1C. Namely, in the case of this magnetic recording medium, it is possible to prevent oxidation of this boundary area S by ensuring corrosion resistance in the magnetic recording area M in the magnetic layer 100 by the carbon protective layer 103 and also covering the surface of the boundary area S with a barrier layer.

In the present invention, it is also considered that the thickness of the carbon protective layer 103 on the surface of the magnetic recording area M may be the same as that on the surface of the boundary area S. However, when such a structure is adopted, the carbon protective layer has a distribution in a thickness direction because of a slight change in the manufacturing conditions of the magnetic recording medium, and thus a possibility of dispersion in environmental resistance characteristics of the magnetic recording medium may increase.

The barrier layer is provided between the magnetic layer 100 and the carbon protective layer 103 in the boundary area S, but can also be provided between the magnetic layer 100 and the carbon protective layer 103 in the magnetic recording area M. However, when the barrier layer is provided between the magnetic layer 100 and the carbon protective layer 103 in the magnetic recording area M, since a material containing mainly Cr or Ti used for the barrier layer is often a non-magnetic material, a distance between the magnetic head and the magnetic layer in the magnetic recording reproducing apparatus increases, resulting in deterioration of magnetic recording reproducing characteristics of the magnetic recording medium. Therefore, in the present invention, since the magnetic layer 100 includes the convex part 101 and the concave part 102, it is desired to provide the barrier layer so as to fill the concave part 102 in view of prevention of deterioration of electromagnetic conversion characteristics of the magnetic recording medium and smoothing of the surface of the magnetic layer 100.

In the magnetic recording medium having the above structure, since moisture and oxygen penetrated from the thin portion of the carbon protective layer are shielded by the barrier layer, it is possible to prevent corrosion of the magnetic layer. Therefore, according to the present invention, it is possible to provide a magnetic recording medium that is excellent in corrosion resistance of a magnetic layer, and has particularly high environmental resistance under a high-temperature and high-humidity environment, and is also excellent in productivity.

### (Method for Manufacturing Magnetic Recording Medium)

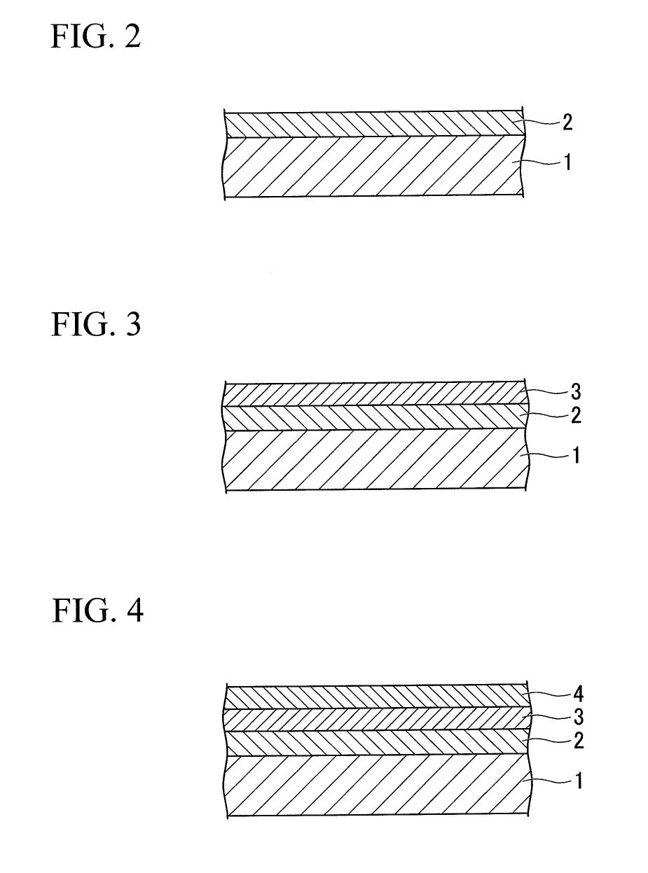

Specific step of manufacturing a magnetic recording medium to which the present invention is applied will be described with reference to FIGS. 2 to 12.

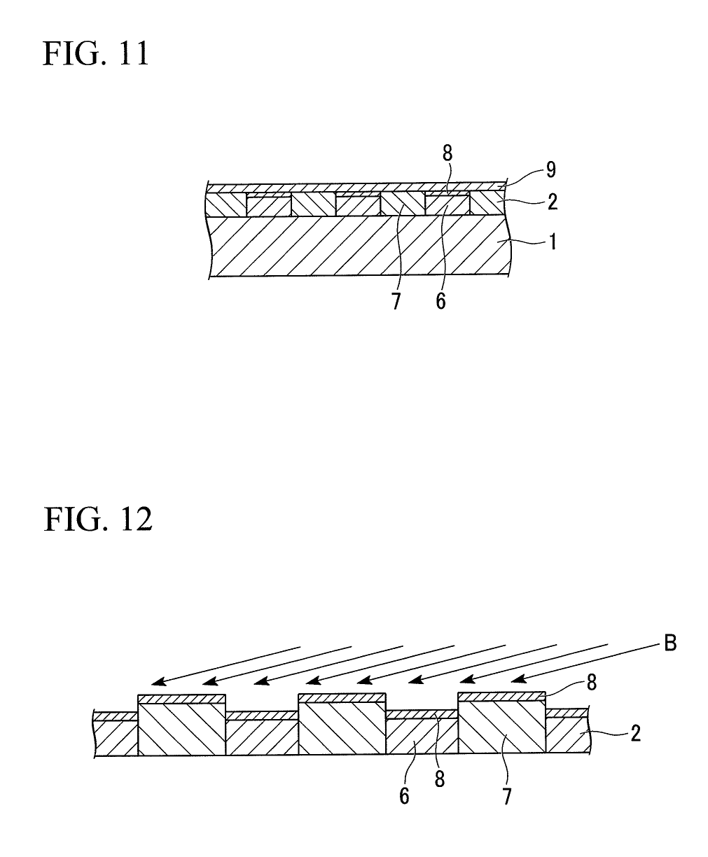

As shown in FIG. 11, the magnetic recording medium to be manufactured by applying the present invention has a structure in which a soft magnetic layer, an intermediate layer, a magnetic layer with a magnetic pattern formed thereon, and a carbon protective layer are laminated on the surface of a non-magnetic substrate in this order, and also lubricating layer is formed on the outermost surface.

In the magnetic recording medium, components other than the non-magnetic substrate, the magnetic layer and the carbon protective layer may be carried out with appropriate modifications without departing from the gist of the invention, including materials and dimensions thereof. Therefore, in FIGS. 2 to 12, illustrations of the soft magnetic layer, the intermediate layer and the lubricating layer are omitted.

In the case of manufacturing this magnetic recording medium, as shown in FIG. 2, a continuous magnetic layer 2 is formed on a non-magnetic substrate 1 (hereinafter referred to as a step A).

It is possible to use, as the non-magnetic substrate 1, any of non-magnetic substrates such as an Al alloy substrate made of, for example, an Al—Mg alloy containing Al as a main component; and substrates made of conventional soda glasses, aluminosilicate-based glasses, crystallized glasses, silicon, titanium, ceramics and various kinds of resins. Among these substrates, an Al alloy substrate, a glass-based substrate such as a crystallized glass substrate, or a silicon substrate is preferably used.

The average surface roughness (Ra) of the non-magnetic substrate 1 is preferably 1 nm or less, more preferably 0.5 nm or less, and particularly preferably 0.1 nm or less.

It is possible to use, as the material of the magnetic layer 2, a magnetic material containing an oxide in the amount within a range from 0.5 atomic % to 6 atomic %. Specifically, it is preferred to use a magnetic alloy containing mainly Co as a main component. Examples of the magnetic alloy include alloys composed of CoCr, CoCrPt, CoCrPtB, CoCrPtB—X and CoCrPtB—X—Y, containing an oxide added therein; and Co-based alloys such as CoCrPt—O, CoCrPt—SiO₂, CoCrPt—Cr₂O₃, CoCrPt—TiO₂, CoCrPt—ZrO₂, CoCrPt—Nb₂O₅, CoCrPt—Ta₂O₅, CoCrPt—Al₂O₃, CoCrPt—B₂O₃, CoCrPt—WO₂ and CoCrPt—WO₃. X in the above constituent materials represents Ru or W, and Y represents Cu or Mg.

In order to obtain given or more output in the case of reproducing, certain thickness or more of the magnetic layer 2 is required. On the other hand, since various parameters representing recording reproducing characteristics usually deteriorate with an increase in output, it is necessary to optimally set the thickness of the magnetic layer 2. Specifically, the thickness of the magnetic layer 2 is preferably set to 3 nm or more and 20 nm or less, and more preferably 5 nm or more and 15 nm or less. As described above, the magnetic layer 2 may be formed so as to obtain sufficient head output/input according to the kind and laminated structure of magnetic alloys to be used.

As shown in FIG. 3, a mask layer 3 is formed on the magnetic layer 2 (hereinafter referred to as a step B). The mask layer 3 can be formed of a material containing any one or more kinds selected from the group consisting of Ta, W, Ta nitride, W nitride, Si, SiO₂, Ta₂O₅, Re, Mo, Ti, V, Nb, Sn, Ga, Ge, As and Ni. Among these, it is preferred to use As, Ge, Sn or Ga, more preferably Ni, Ti, V or Nb, and most preferably Mo, Ta or W. Commonly, the thickness of the mask layer 3 is preferably within a range from 1 nm to 20 nm.

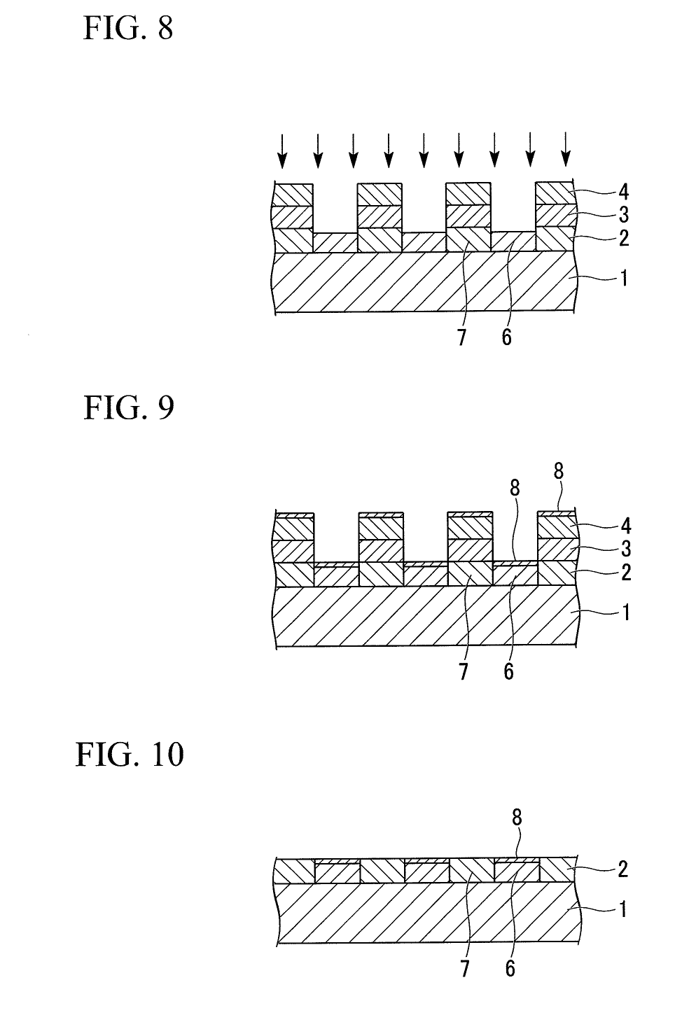

Use of these materials enables the improvement of the shielding property of the mask layer 3 to milling ions and the improvement of magnetic recording area-forming characteristics by means of the mask layer 3. Furthermore, since these substances are easily dry-etched with a reactive gas, it is possible to decrease the residual substance and to reduce contamination on the surface of magnetic recording medium in a step H shown in FIG. 9 that is shown hereinafter.

Next, as shown in FIG. 4, a resist layer 4 is formed on the mask layer 3 (hereinafter referred to as a step C). It is possible to use, as the material of the resist layer 4, resist material that is cured under irradiation with radiation, for example, ultraviolet-curable resins such as novolak-based resins, acrylic acid esters and alicyclic epoxy resins.

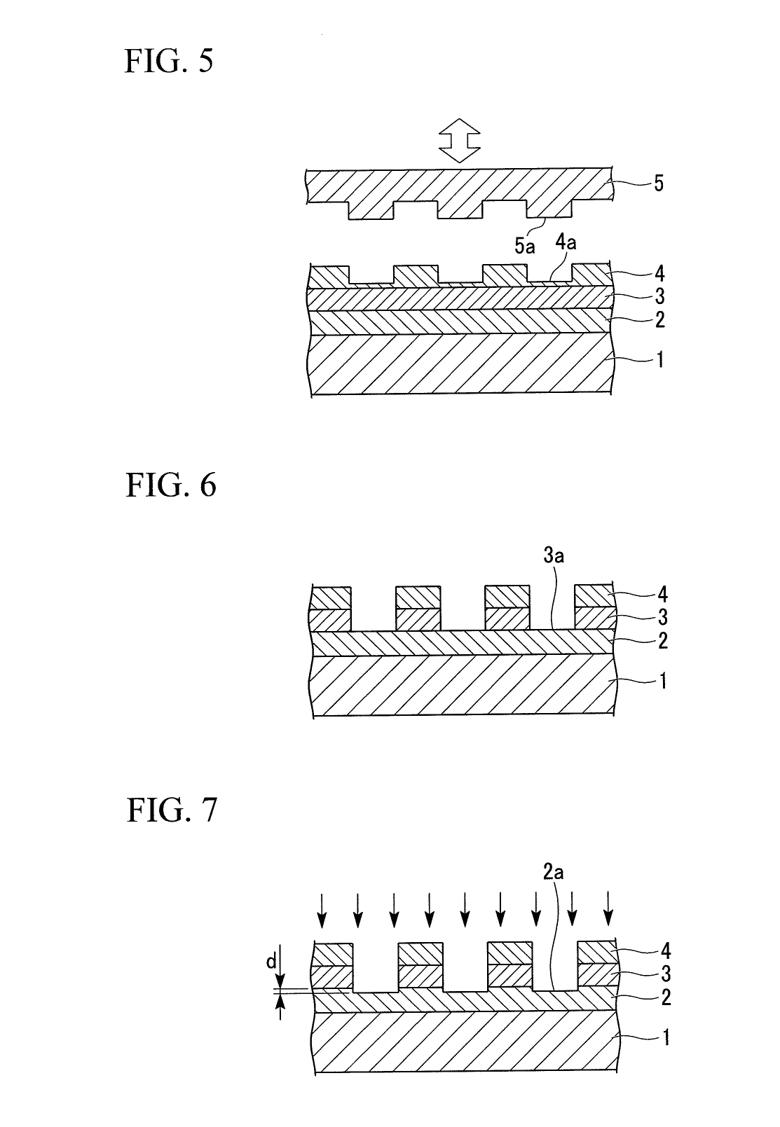

Next, as shown in FIG. 5, the mask layer 3 is patterned (hereinafter referred to as a step D).

Specifically, using a stamp 5 made of a glass or resin that is highly transmissive to ultraviolet rays, a negative pattern is transferred to the resist layer 4. The negative pattern is obtained by forming a concave part 4a on the resist layer 4 of the magnetic layer 2 corresponding to a boundary area that separates a magnetic recording area (recording track).

The stamp 5 is obtained, for example, by transferring a convex part 5a corresponding to the track pattern using a stamper obtained by forming a fine track pattern (concave part) corresponding to the recording pattern on a metal plate by an electron beam lithographic method. Since hardness and durability demands for the process are required to the material of the stamper, for example, Ni is used. However, the material of the stamper is not limited to such a material as long as it achieves the object described above. In addition to the track pattern corresponding to the recording track for recording data, patterns corresponding to servo signal, such as a burst pattern, a gray code pattern and a preamble pattern, may be formed and these patterns may be transferred to the stamp 5.

In the case of transferring a negative pattern to the resist layer 4 using such a stamp 5, the stamp 5 is pressed against the resist layer 4, as indicated by the arrow in FIG. 5, in a state where the resist layer 4 has high fluidity. In a state where the stamp 5 is pressed against the resist layer 4, the resist layer 4 is cured by irradiating with radiation, and then the stamp 5 is separated from the resist layer 4. Thus, a concave part 4a can be formed on the resist layer 4 of the magnetic layer 2 corresponding to the boundary area.

It becomes possible to transfer the shape of the stamp 5 to the resist layer 4 with high accuracy by using such a manufacturing method. It is also possible to improve the shielding property of the mask layer 3 to injected ions by eliminating sagging at the edge portion of the mask layer 3 in the etching step of the mask layer 3 that is described hereinafter. It is also possible to improve magnetic recording area-forming characteristics by means of the mask layer 3.

Examples of the method of irradiating the resist layer 4 with radiation in a state where the stamp 5 is pressed against the resist layer 4 include a method of irradiating with radiation from the opposite side of the stamp 5, namely, the non-magnetic substrate 1, a method of selecting a substance capable of transmitting radiation as the material of the stamp 5 and irradiating radiation form the stamp 5 side, and a method of irradiating with radiation from the side of the stamp 5. It is also to use a method of irradiation with radiation through heat conduction from the stamp 5 or non-magnetic substrate 1 side using radiation having high conductivity to a solid, such as heat rays. In the case of transferring a negative pattern to the resist layer 4 using the stamp 5, it is also possible to irradiate the resist layer 4 with radiation after transferring the pattern.

The radiation as used herein refers to electromagnetic waves in a broad sense, such as heat rays, visible rays, ultraviolet rays, X-rays and gamma rays. The material that is cured by irradiation with radiation may be a thermosetting resin for heat rays and an ultraviolet-curable resin for ultraviolet rays.

The thickness of the concave part 4a to be formed on the resist layer 4 is preferably adjusted within a range from 0 to 10 nm. When the thickness of the concave part 4a is adjusted within the above range, it is possible to improve the shielding property of the mask layer 3 to milling ions by eliminating sagging at the edge portion of the mask layer 3, and to improve magnetic recording area-forming characteristics by means of the mask layer 3 in the etching step of the mask layer 3 that is described hereinafter. The thickness of the resist layer 4 is commonly from about 10 nm to 100 nm.

Next, as shown in FIG. 6, a concave part 3a is formed by removing the mask layer 3 of the portion corresponding to the concave part 4a of the resist layer 4 (hereinafter referred to as a step E). In this step E, when the resist layer 4 remains on the bottom the concave part 4a, the remaining resist layer 4 is removed together with the mask layer 3.

Next, as shown in FIG. 7, a concave part 2a is formed by removing a portion of the surface layer of the magnetic layer 2 through ion milling (hereinafter referred to as a step F).

The depth d of the concave part 2a is preferably adjusted within a range from 0.1 to 15 nm, and more preferably from 1 to 10 nm. When the depth d of the concave part 2a is less than 0.1 nm, the effect of removing the magnetic layer 2 is not exerted. In contrast, when the depth d of the concave part 2a is more than 15 nm, surface smoothness of the magnetic recording medium becomes worse, resulting in deterioration of levitation characteristics of the magnetic head in the case of manufacturing a magnetic recording reproducing apparatus.

The above step F can also be omitted. In this case, it is possible to fowl an etched concave part 2a on the magnetic layer 2 by exposing the exposed surface of the magnetic layer 2 to reactive plasma or reactive ions in a step G described hereinafter. Therefore, when the above ion milling step and the step of exposing to reactive plasma or reactive ions are provided, the depth d of the concave part 2a becomes the total depth.

Next, as shown in FIG. 8, by exposing the portion (concave part 2a) removed by ion milling of the magnetic layer 2 to reactive plasma or reactive ions, magnetic characteristics of the magnetic layer 2 of the portion are modified. Thus, it is possible to separate a magnetic recording area 7 by the modified boundary area 6 of the magnetic layer 2 (hereinafter referred to as a step G).

In the present invention, modification of magnetic characteristics of the magnetic layer 2 refers to partial change of coercive force and residual magnetization of the magnetic layer 2, in addition to non-magnetization of the boundary area 6 for the purpose of separating the magnetic recording area 7 of the magnetic layer 2, and the change refers to a decrease in coercive force and a decrease in residual magnetization.

As one of methods of modifying magnetic characteristics of the magnetic layer 2, for example, there is exemplified a method of converting the magnetic layer 2 into an amorphous state by exposing the formed magnetic layer 2 to reactive plasma or reactive ions. Namely, modification of magnetic characteristics of the magnetic layer 2 also includes realization through variation of a crystal structure of the magnetic layer 2.

In the present invention, conversion of the magnetic layer into an amorphous state refers to conversion of atomic arrangement of a magnetic layer into a form of irregular atomic arrangement with no long-distance order, and more specifically refers to conversion into a state where fine crystal grains having a grain size of less than 2 nm are arranged at random. When the state of atomic arrangement is confirmed by an analytical method, a state where a peak assigned to a crystal plane is not recognized and only halo is recognized is confirmed by X-ray diffraction or electron beam diffraction.

In the present invention, although the magnetic layer 2 is modified by exposing the formed magnetic layer 2 to reactive plasma or reactive ions, it is preferred to realize the modification by the reaction of magnetic metal constituting the magnetic layer 2 with atoms or ions in reactive plasma. The reaction as used herein includes a change in crystal structure of magnetic metal caused by penetration of atoms in reactive plasma into magnetic metal, a change in composition of magnetic metal, oxidation of magnetic metal, nitriding of magnetic metal and silicification of magnetic metal.

Examples of the reactive plasma include inductively coupled plasma (ICP) and reactive ion plasma (RIE).

Examples of the reactive ions include reactive ion that exist in inductively coupled plasma and reactive ion plasma.

The inductively coupled plasma is high-temperature plasma obtained by applying a high voltage to a gas thereby converting into plasma, and generating Joule heat caused by eddy current inside plasma by means of high-frequency variable magnetic field. The inductively coupled plasma has high electron density and can realize modification of magnetic characteristics with high efficiency in a magnetic layer with a wide area as compared with the case of manufacturing a discrete track medium using prior art ion beam.

The reactive ion plasma is highly reactive plasma obtained by adding a reactive gas such as O₂, SF₆, CHF₃, CF₄ or CCl₄ in plasma. It becomes possible to realize modification of magnetic characteristics of the magnetic layer 2 with high efficiency by using such plasma as the reactive plasma of the present invention.

In the present invention, it is preferred that the reactive plasma or reactive ions contain halogen ions. It is preferred that halogen ions are halogen ions formed by introducing any one or more kinds halogenated gasses selected from the group consisting of CF₄, SF₆, CHF₃, CCl₄ and KBr in view of enhancing reactivity of the magnetic layer 2 with plasma and making a formed pattern sharp.

Detailed reason is not apparent but is considered that a foreign material formed on the surface of the magnetic layer 2 is etched by halogen atoms in reactive plasma thereby cleaning the surface of the magnetic layer 2, resulting in an increase of the magnetic layer 2. It is also considered that the cleaned surface of the magnetic layer 2 undergoes a reaction with halogen atoms with high efficiency.

In the present invention, when a portion of the surface layer of the magnetic layer 2 is removed and then the surface is exposed to reactive plasma or reactive ions thereby modifying magnetic characteristics of the magnetic layer 2, contrast of a magnetic recording area becomes more clear than that in the case where a portion of the magnetic layer 2 is not removed, and also S/N of the magnetic recording medium was improved.

This reason is considered that, by removing a portion of the surface layer of the magnetic layer 2, cleaning and activation of the part are achieved and reactivity with reactive plasma or reactive ions is enhanced, and defects such as vacancy are introduced into the surface layer of the magnetic layer 2 and thus reactive ions are likely to penetrate into the magnetic layer 2 via the defects.

Next, as shown in FIG. 9, a barrier layer 8 containing mainly Cr or Ti is formed at a boundary area 6 of the modified magnetic layer 2 and the surface of the resist layer 4 (hereinafter referred to as a step H).

The barrier layer 8 can use, as the material containing mainly Cr or Ti, Cr and Ti as well as an alloy containing mainly Cr or Ti such as CrMo, CrW, CrCo, CrTi, TiN or TiCo. The alloy containing mainly Cr or Ti means that a constituent element having a first atomic ratio is Cr or Ti. Cr or Ti is a material suited to shield diffusion of moisture or oxygen in atmospheric air since it has high corrosion resistance and has a dense crystal structure. It is possible to use a sputtering method as a method of forming a barrier layer 8.

The thickness of the barrier layer 8 is preferably within a range from 0.3 to 5 nm. When the thickness of the barrier layer 8 is adjusted within the above range, it becomes possible to shield diffusion of moisture or oxygen in atmospheric air into the magnetic layer, and to make the surface of the magnetic recording medium smooth.

Next, as shown in FIG. 10, the resist layer 4 and the mask layer 3 are removed (hereinafter referred to as a step I). In this step I, the resist layer 4 and the mask layer 3 are removed and, at the same time, the barrier layer 8 on the resist layer 4 is also removed through lift-off. Dry etching, reactive ion etching, ion milling or wet etching can be used so as to remove the resist layer 4 and the mask layer 3.

In the case of removing the barrier layer 8 formed on the surface of the magnetic recording area 7, it is possible to employ a method of irradiating the surface of the magnetic recording area 7 with ion beam from an oblique direction. This is the method in which the barrier layer 8 formed on the magnetic recording area 7 (convex part) is selectively etched by irradiating the surface of the magnetic recording area 7 with ion beam B from an oblique direction, as shown in FIG. 12, thus burying the barrier layer 8 into only the boundary area 6 (concave part) on the surface of magnetic layer 2 having the boundary area 6 (concave part).

After removing the resist layer 4 and the mask layer 3, it is preferred to provide a step of irradiating the magnetic layer 2 activated in the above steps F, G and H with an inert gas. By providing such a step, the magnetic layer 2 is stabilized and the occurrence of migration of magnetic particles is suppressed even under a high-temperature and high-humidity environment. This reason is not apparent but is considered that, when an inert element penetrates into the surface of the magnetic layer 2, movement of magnetic particles is suppressed. Alternatively, irradiation of an inert gas enables removal of the active surface of the magnetic layer 2 and suppression of migration of magnetic particles.

It is preferred to use, as the inert gas, any one or more kinds of gasses selected from the group consisting of Ar, He and Xe. Because these elements are stable and magnetic particles have high effects of suppressing migration. It is preferred to use any one method selected from the group consisting of ion gun, ICP and RIE in the case of irradiation with an inert gas. Among these methods, ICP or RIE is used particularly preferably in view of a large irradiation dose.

Next, as shown in FIG. 11, a carbon protective layer 9 that covers the surfaces of the magnetic layer 2 and the barrier layer 8 is formed (hereinafter referred to as a step J). In the case of forming the carbon protective layer 9, a diamond like carbon (DLC) thin film is preferably formed using a CVD method. Although a CVD method and a CVD film formation device used in the present invention are known, it is preferred to use a CVD film formation device described below so as to increase the thickness of the carbon protective layer 9 on the magnetic recording area 7 of the magnetic layer 2 as compared with that on the boundary area 6.

The CVD film formation device may be provided with a chamber that accommodates a disk; electrodes disposed so as to oppose to each other inside both side wall faces of the chamber; a high-frequency power supply that supplies high-frequency electric power to these electrodes; a bias power supply that can be connected to the disk in the chamber; and a supply source of a reaction gas that would be a raw material of a carbon protective layer 9 to be formed on the disk.

To the chamber, an introduction pipe through which a reaction gas is introduced into the chamber, and an exhaust pipe through which the gas in the chamber is discharged out of the system are connected. The exhaust pipe is provided with a displacement control valve, whereby an internal pressure of the chamber can be set to any value by controlling the displacement.

It is preferred to use, as the high-frequency power supply, a high-frequency power supply that can supply electric power of 50 to 2,000 W to electrodes when the carbon protective layer 9 is formed.

It is preferred to use, as the bias power supply, a high-frequency power supply or a pulsed-DC power supply so as to concentrate plasma at the convex part of the magnetic recording area 7, thereby to increase radical density of the convex part and to increase the film formation rate of the convex part.

It is preferred that the high-frequency power supply can apply high-frequency electric power of 10 to 300 W to the disk. It is preferred to use, as the pulsed-DC power supply, a pulsed-DC power supply that can apply a voltage (average voltage) of −400 to −10 V to the disk at a pulse width within a range from 10 to 50,000 ns and a frequency within a range from 10 kHz to 1 GHz.

Preferably, a lubricating layer is formed on the protective layer 9. Examples of the lubricant to be used in the lubricating layer include a fluorine-based lubricant, a hydrocarbon-based lubricant and mixtures thereof. The lubricant layer is usually formed in the thickness of 1 to 4 nm.

In the magnetic recording medium manufactured through the manufacturing steps described above, it is possible to eliminate bleeding during magnetic recording to obtain high surface recording density by allowing magnetic characteristics of a boundary area 6 of a magnetic layer 2 to deteriorate, for example, by reducing coercive force and residual magnetization to the upmost limit. According to the present invention, it is possible to manufacture such a magnetic recording medium by a simple and easy manufacturing process.

### (Magnetic Recording Reproducing Apparatus)

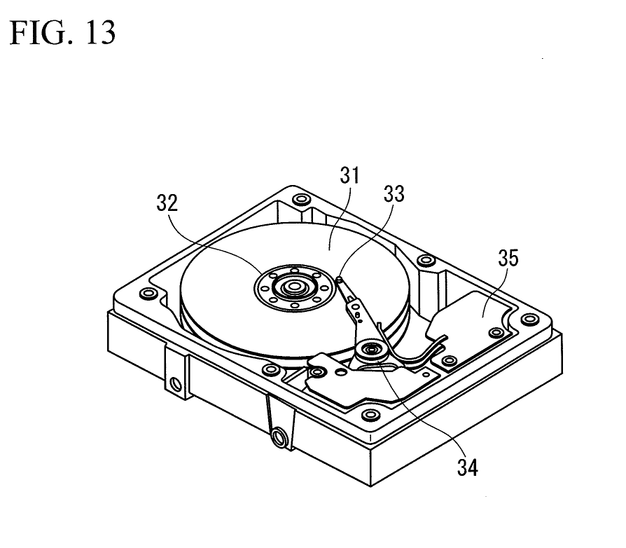

An exemplary configuration of a magnetic recording reproducing apparatus (HDD) to which the invention is applied is shown in FIG. 13.

As shown in FIG. 13, the magnetic recording reproducing apparatus to which the invention is applied includes a magnetic disk (magnetic recording medium) 31; a rotation driving section that rotationally drives the magnetic recording medium 31 (medium driving section that drives the magnetic recording medium in a recording direction) 32; a magnetic head 33 that performs a recording operation and a reproducing operation to the magnetic disk 31; a head driving section that moves the magnetic head 33 to a radial direction of the magnetic disk 31 (head moving means that moves the magnetic head relative to the magnetic recording medium) 34; and a recording reproducing signal processing system that inputs signals to the magnetic head 33 and reproduces signals output from the magnetic head 33 (recording reproducing signal processing means) 35.

When the magnetic recording medium to which the above present invention is applied is used in the magnetic recording reproducing apparatus, it becomes possible to form a magnetic recording reproducing apparatus having high recording density. In the related art magnetic recording reproducing apparatuses, the reproducing head width has a smaller width than that of the recording head width so as to eliminate influence of a magnetization transition region of a track edge portion. By forming a recording track of the magnetic recording medium in a magnetically discontinuous manner, the reproducing head may have the same width as that of the recording head. Accordingly, sufficient reproduction output and a high SNR can be obtained.

Furthermore, when a reproducing section of the magnetic head 33 is formed by a GMR head or a TMR head, sufficient signal intensity can be obtained even in high recording density, and thus a magnetic recording reproducing apparatus with high recording density can be obtained. When a levitation amount of the magnetic head 33 is within a range from 0.005 μm to 0.020 μm, which is lower than that in the related art, output is improved and a high device SNR is obtained, and thus a high-capacity and highly reliable magnetic recording reproducing apparatus can be provided. When a signal processing circuit for maximum likelihood decoding is used in combination, it is possible to further increase the recording density. A sufficient SNR can be obtained even when data is recorded and reproduced at, for example, track density of 100 or more ktracks per inch, linear recording density of 1,000 or more kbits per inch and recording density of 100 or more Gbits per square inch.

### Examples

Hereinafter, effects of the invention will be described in more detail by way of Example. It should be noted that the invention is not limited to the following Examples and modifications may be made without departing from the spirit and scope of the invention.

### Example 1

In Example 1, a vacuum chamber with a HD glass substrate (having a disk shape) disposed therein was evacuated to 1.0×10⁻⁵ Pa or less in advance. The glass substrate used herein was a crystallized glass substrate containing Li₂Si₂O₅, Al₂O₃—K₂O, Al₂O₃—K₂O, MgO—P₂O₅ and Sb₂O₃—ZnO as constituent components, and having an outer diameter of 65 mm, an inner diameter of 20 mm and an average surface roughness (Ra) of 2 angstroms.

On a glass substrate, a 65Fe-30Co-5B film as a soft magnetic layer, a Ru film as an intermediate layer, and a perpendicular magnetic layer having a granular structure as a magnetic layer were formed using a DC sputtering method. The magnetic layer had an alloy composition of Co-10Cr-20Pt-8(SiO₂) (in molar ratio) and the thickness was adjusted to 150 Å. Concerning the thickness of other layers, the thickness of a FeCoB soft magnetic layer was adjusted to 600 Å and that of a Ru intermediate layer was adjusted to 100 Å. A mask layer was formed thereon using a sputtering method. The mask layer was formed using Ta and the thickness was adjusted to 60 nm. A resist was coated thereon using a spin coating method. A novolak-based resin that is an ultraviolet-curable resin was used as the resist. The thickness was adjusted to 100 nm.

Using a glass stamp having a negative pattern of a magnetic recording area, the stamp was pressed against the resist layer under a pressure of 1 MPa (about 8.8 kgf/cm²). In this state, the resist layer was cured by irradiating with ultraviolet rays having a wavelength of 250 nm for 10 seconds from above the glass stamp having an ultraviolet transmittance of 95% or more. The stamp was then removed from the resist layer and the magnetic recording area was transferred to the resist layer. The pattern of the magnetic recording area transferred to the resist layer had a circular configuration having a width of 120 nm at the convex part of the resist and a circular configuration having a width of 60 nm at the concave part of the resist. The thickness of the resist layer was 80 nm and depth of the concave part of the resist was about 5 nm. An angle of concave part of the resist layer was about 90 degrees with respect to the surface of the substrate.

Next, the concave part of the resist layer and the Ta layer under the resist layer were removed by dry etching. Dry etching was conducted using 40 sccm of an O₂ gas under the conditions of a pressure of 0.3 Pa, a high-frequency plasma electric power of 300 W, a DC bias of 30 W and an etching time of 10 seconds for etching of the resist layer, while dry etching was conducted using 50 sccm of a CF₄ gas under the conditions of a pressure of 0.6 Pa, a high-frequency plasma electric power of 500 W, a DC bias of 60 W and an etching time of 30 seconds for etching of the Ta layer.

Next, the surface of the portion where the magnetic layer is not coated with the mask layer was removed by ion milling. The depth of the layer removed by ion milling was 4 nm. Ar ions were used in ion milling. Ion milling was conducted under the conditions of a high-frequency discharge power of 800 W, an acceleration voltage of 500 V, a pressure of 0.014 Pa, an Ar flow rate of 5 sccm and a current density of 0.4 mA/cm². The surface subjected to ion milling was exposed to reactive plasma, and magnetic characteristics of the magnetic layer of the portion were modified. In the reactive plasma treatment of the magnetic layer, an inductively coupled plasma device NE550 manufactured by ULVAC, Inc. was used. The reactive plasma treatment was conducted using a 90 cc/minute of a CF₄ gas as a gas for generation of plasma under the conditions of an electric power of 200 W, a pressure in a device of 0.5 Pa and a treating time of 300 seconds. After displacing the CF₄ gas by an oxygen gas, the magnetic layer was treated for 50 seconds. In the magnetic layer, on the surface subjected to modification of magnetic characteristics, a 4 nm thick layer made of Cr was formed as a barrier layer.

Next, the resist layer and the mask layer were removed through dry etching. The dry etching was conducted using 100 sccm of an SF₆ gas under the conditions of a pressure of 2.0 Pa, a high-frequency plasma electric power of 400 W and a treating time of 300 seconds. Next, argon ions were injected into the surface of the magnetic layer. The injection of argon ions was conducted using 5 sccm of an argon gas under the conditions of a pressure of 0.014 Pa, an acceleration voltage of 300 V, a current density of 0.4 mA/cm² and a treating time of 10 seconds. The resist layer and the mask layer were removed through dry etching.

On the surface, a carbon (diamond like carbon (DLC)) protective layer was formed by a CVD method. The carbon protective layer was formed using an RF plasma CVD device under the conditions of an applied electric power of 13.56 MHz, 500 W and a film formation time of 10 seconds. In the case of foaming the carbon protective layer, a DC pulse voltage of −150 V, a pulse width of 200 nm and a frequency of 200 kHz was applied to a substrate. Next, Z-dol 2000 as a lubricant was coated in a thickness of 20 angstroms to obtain a magnetic recording medium.

Environmental resistance of the magnetic recording medium manufactured as described above was evaluated.

The evaluation was conducted by the following procedure. After maintaining the magnetic recording medium under an atmospheric environment at a temperature of 80° C. and a humidity of 85% for 96 hours, the number of corrosion spots having a diameter of 5 micronφ or more formed on the surface of the magnetic recording medium was counted.

On the surface of the magnetic recording medium, 5 parts (100 microliter/portion) of an aqueous 3% nitric acid solution and 5 parts (100 microliter/portion) of pure water were respectively dropped. After standing for 1 hour, these liquids were collected and the amount of Co contained therein was measured using ICP-MS. In the measurement using ICP-MS, 1 milliliter of 3% nitric acid containing 200 ppt of Y was used as a standard liquid. As a result, the number of corrosion spots was 1/surface and the amount of cobalt extracted was 0.12 microgram/surface.

### Example 2

In Example 2, a magnetic recording medium was prepared under the same conditions as in Example 1, except that a Ti film was formed as the barrier layer. Next, environmental resistance of the magnetic recording medium of Example 2 was evaluated. As a result, the number of corrosion spots was 1/surface and the amount of cobalt extracted was 0.41 microgram/surface.

### Comparative Example 1

In Comparative Example 1, a magnetic recording medium was prepared under the same conditions as in Example 1, except that the barrier layer was not formed. Next, environmental resistance of the magnetic recording medium of Comparative Example 1 was evaluated. As a result, the number of corrosion spots was 19/surface and the amount of cobalt extracted was 0.39 microgram/surface.

### INDUSTRIAL APPLICABILITY

According to the present invention, it becomes possible to provide a magnetic recording medium that has high recording density and has high corrosion resistance, particularly environmental resistance of a magnetic recording area, and is therefore excellent in durability, with high productivity. Accordingly, the present invention has great industrial applicability.

1. A magnetic recording medium comprising, on a substrate, at least a magnetic layer and a carbon protective layer that covers the magnetic layer, wherein
a convex part serving as a magnetic recording area, and a concave part serving as a boundary area that separates the magnetic recording area are provided on the surface of the magnetic layer, and
a barrier layer containing mainly Cr or Ti is formed between the concave part serving as the boundary area and the carbon protective layer.

2. The magnetic recording medium according to claim 1, wherein the boundary area is formed by modifying a portion of the magnetic layer.

3. The magnetic recording medium according to claim 1, wherein the thickness of the carbon protective layer on the magnetic recording area is more than the thickness of the carbon protective layer on the boundary area.

4. The magnetic recording medium according to claim 1, wherein the thickness of the barrier layer is from 0.3 to 5 nm.

5. A method for manufacturing a magnetic recording medium, comprising the steps of:
forming a magnetic layer on a substrate;
forming a concave part serving as boundary area that separates a magnetic recording area, on the surface of the magnetic layer;
forming a barrier layer containing mainly Cr or Ti at the concave part; and
forming a carbon protective layer that covers the magnetic layer and the barrier layer.

6. The method for manufacturing a magnetic recording medium according to claim 5, wherein the step of forming the concave part serving as the boundary area that separates the magnetic recording area, on the surface of a magnetic layer includes the substeps of:
forming a mask layer on the magnetic layer;
forming a resist layer on the mask layer;
forming a concave part at the position corresponding to the boundary area of the resist layer;
removing the mask layer at the part corresponding to the concave part; and
exposing the exposed surface of the magnetic layer at a portion where the mask layer is removed, to reactive plasma or reactive ions, thereby modifying the magnetic layer at the part.

7. The method for manufacturing a magnetic recording medium according to claim 6, wherein, in the substep of forming the concave part at the position corresponding to the boundary area of the resist layer, the resist layer is irradiated with radiation in a state where a stamp is pressed against the resist layer, thereby transferring a shape of the stamp to the resist layer.

8. The method for manufacturing a magnetic recording medium according to claim 6, wherein a portion of the magnetic layer at a portion where the mask layer is removed is removed through ion milling.

9. The method for manufacturing a magnetic recording medium according to claim 6, wherein the step of forming the barrier layer containing mainly Cr or Ti at the concave part includes the substeps of:
forming the barrier layer on the surface of the magnetic layer and on the resist layer; and
removing the resist layer and the mask layer and also removing the barrier layer on the resist layer through lift-off.

10. The method for manufacturing a magnetic recording medium according to claim 9, wherein, when the barrier layer formed on the magnetic recording area of the magnetic layer is selectively removed, the surface of the magnetic recording area is irradiated with ion beam from an oblique direction.

11. A magnetic recording reproducing apparatus comprising:
the magnetic recording medium according to claim 1;
a medium driving unit that drives the magnetic recording medium in a recording direction;
a magnetic head that performs a recording operation and a reproducing operation to the magnetic recording medium;
a head moving unit that moves the magnetic head relative to the magnetic recording medium; and
a recording reproducing signal processing unit that inputs signals to the magnetic head and reproduces signals output from the magnetic head.

12. A magnetic recording reproducing apparatus comprising:
the magnetic recording medium according to claim 2;
a medium driving unit that drives the magnetic recording medium in a recording direction;
a magnetic head that performs a recording operation and a reproducing operation to the magnetic recording medium;
a head moving unit that moves the magnetic head relative to the magnetic recording medium; and
a recording reproducing signal processing unit that inputs signals to the magnetic head and reproduces signals output from the magnetic head.

13. A magnetic recording reproducing apparatus comprising:
the magnetic recording medium according to claim 3;
a medium driving unit that drives the magnetic recording medium in a recording direction;
a magnetic head that performs a recording operation and a reproducing operation to the magnetic recording medium;
a head moving unit that moves the magnetic head relative to the magnetic recording medium; and
a recording reproducing signal processing unit that inputs signals to the magnetic head and reproduces signals output from the magnetic head.

14. A magnetic recording reproducing apparatus comprising:
the magnetic recording medium according to claim 4;
a medium driving unit that drives the magnetic recording medium in a recording direction;
a magnetic head that performs a recording operation and a reproducing operation to the magnetic recording medium;
a head moving unit that moves the magnetic head relative to the magnetic recording medium; and
a recording reproducing signal processing unit that inputs signals to the magnetic head and reproduces signals output from the magnetic head.
